(19) United States
(12) Patent Application Publication
(10) Pub. No.: US 2013/0149548 A1
(43) Pub. Date: Jun. 13, 2013

(54) Fire Retardant

(71) Applicant: Llewellyn Angelo Williams, New Rochelle, NY (US)

(72) Inventor: Llewellyn Angelo Williams, New Rochelle, NY (US)

(21) Appl. No.: 13/646,304

(22) Filed: Oct. 5, 2012

Related U.S. Application Data
(60) Provisional application No. 61/545,043, filed on Oct. 7, 2011.
(60) Provisional application No. 61/568,577, filed on Dec. 8, 2011.

(51) Int. Cl. C09K 21/14; E04B 2/84

(52) U.S. Cl. CPC C09K 21/14; E04B 2/842
USPC 428/532; 427/421.1; 252/601

(57) ABSTRACT

A method for creating a fire retardant mixture. The method may include grinding an exoskeleton of an aquatic invertebrate into a powder. Once the exoskeleton has been ground, mixing the ground exoskeleton with a mixing material. Finally, applying the mixture to a base material to increase the fire retardant properties of the base material. Some examples of a base material include fabric, wood, drywall panels, and waterproof fabric.

### CROSS-REFERENCE TO RELATED APPLICATIONS

This application claims the benefit of U.S. Provisional Patent Application No. 61/545,043 filed Oct. 7, 2011 entitled “Fire Retardant,” and U.S. Provisional Patent Application No. 61/568,577 filed Dec. 8, 2012 entitled “Fire Retardant,” both of which are hereby incorporated herein by reference in their entireties.

### FIELD

The present invention relates generally to fire retardant products, and more specifically, to fire retardant mixtures.

### BACKGROUND

Building and clothing materials such as drywall, fabric, drywall panels, leather, and the like may be susceptible to fire damage, which can destroy or significantly damage the materials. For example, a building using timber may be completely destroyed if any portion of the building materials catch on fire. Similarly, a person wearing clothes made of a fire-susceptible fabric may be seriously injured in the event that he or she comes into contact with fire, sparks, or flames. Because many building and clothing materials may have many other beneficial characteristics (i.e., strong, light, soft, etc.), the materials may not be selected based on fire retardant characteristics.

### SUMMARY

Examples of the disclosure may include a method for creating a fire retardant mixture. The method may include grinding an exoskeleton of an aquatic invertebrate into a powder. Once the exoskeleton has been ground, mixing the ground exoskeleton with a mixing material. Finally, applying the mixture to a base material to increase the fire retardant properties of the base material.

Other examples of the disclosure may include another method for creating a fire retardant mixture. The method may include grinding at least a portion of a crustacean outer shell into particles. Once the outer shell is in particles, dispensing the particles into a base substance. Then, mixing the particles and the base substance to form a third material.

Still other examples of the disclosure may include a drywall panel. The dry wall panel may include a liner and a core. The core may be inserted into the liner and may include a plaster and a fire retardant. The fire retardant may include pieces of an exoskeleton of an invertebrate suspended within the plaster.

### BRIEF DESCRIPTION OF THE DRAWINGS

FIG. 1A is a top plan view of a crab having an exoskeleton.

FIG. 1B is a top plan view of a lobster having an exoskeleton.

FIG. 2 is a flow chart illustrating an exemplary method for creating a fire retardant mixture utilizing the exoskeleton of invertebrate animals.

FIG. 3 is a block diagram of a user applying the fire retardant mixture to building materials.

FIG. 4 is a front perspective view a building material having another form of the fire retardant mixture applied thereto.

FIG. 5A is a front elevation view of an article of clothing including the fire retardant mixture.

FIG. 5B is a front elevation view of a shoe including the fire retardant mixture.

FIG. 6 is an enlarged portion of the materials making up the clothing of FIG. 5A and the shoe of FIG. 5B.

### SPECIFICATION

### Overview

In some embodiments herein, a fire retardant mixture for use as a coating or layer for substantially any type of material is disclosed. The fire retardant mixture may be used to coat or cover building materials such as wood, drywall panels, ceilings, beams, etc. The fire retardant mixture may also be used to coat or form a portion of fabrics such as non-wovens, wovens, or knits. In some examples, the fire retardant mixture may be in the form of a foam or a powder and can be applied to practically any material.

The fire retardant mixture may also provide water proofing properties for a base material, e.g., wood, drywall, fabric, and so on. The fire retardant may thus provide fire proofing and water proofing for a variety of materials. In other examples, the fire retardant may enhance the properties of other materials. In one example, the fire retardant may be applied to a substantially waterproof fabric, such as thermo-mechanically expanded polytetrafluoroethylene (PTFE) and other fluoropolymer products (e.g., GOR-TEX), and thus providing fire retardant properties while also increasing the waterproof characteristics of the material.

The fire retardant mixture includes the exoskeletons or outer shells of aquatic invertebrates, e.g., Alaskan King Crab, lobster, mussels, and so on. The exoskeletons may be baked or dried, and broken into pieces or ground to create a powder. The pieces or powder may then be mixed with other substances, such as plaster, foaming agents, adhesive, and the like to create the fire retardant mixture. The fire retardant mixture may then be applied to another material increasing the fire retardant properties of the material.

The exoskeletons of the aquatic invertebrates such as crabs and lobsters used for the fire retardant mixture may included chitin and/or calcium carbonate. These materials may assist in increasing the fire retardant and/or waterproof properties of the material to which the fire retardant mixture is applied. In other examples, the exoskeletons of other non-aquatic invertebrates or the shells or materials of other animals including similar materials (e.g., calcium carbonate, chitin) to that of aquatic invertebrates may also be used for the fire retardant mixture.

The fire retardant mixture as a foam, powder, or solid form may be sprayed or otherwise applied to a material, such as a construction or building material. Additionally, the fire retardant mixture may be formed with another substance to create a third material having increased retardant properties. The fire retardant mixture may be used to enhance and increase the fire retardant properties of materials for buildings, handles for pots and pans, automobiles, airplanes, rockets, as well as clothing, shoes, helmets, drapes, carpets, hats, and the like.

In one example, the fire retardant mixture may be applied to a plaster used to create drywall panels. The drywall panels created with the plaster mixture may then have an increased fire retardant property as the exoskeleton pieces or powder distributed within the plaster may be more fire resistant than other materials used within the plaster or panel. Similarly, the fire retardant mixture may be applied to other building materials, such as composite wood materials, ceiling tiles, and so on.

### DETAILED DESCRIPTION

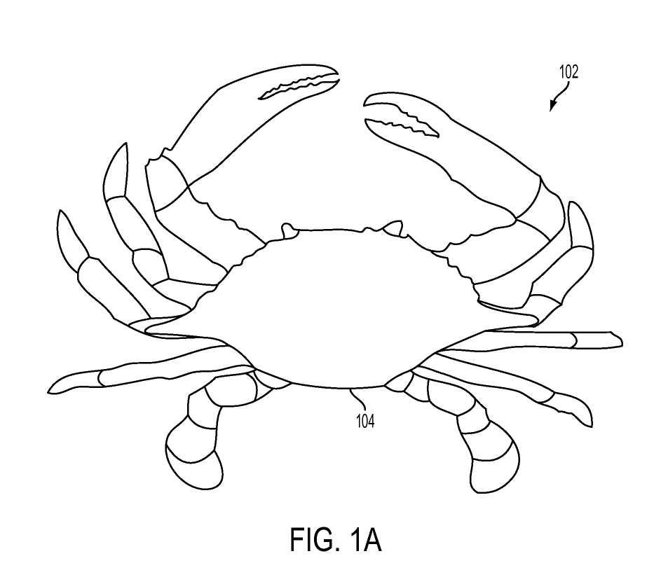

FIG. 1A and FIG. 1B illustrate a top plan view of aquatic invertebrates including exoskeletons. The exoskeleton of the aquatic invertebrates of FIGS. 1A and 1B may be removed, and as discussed in more detail below, processed and combined with other materials to create a fire retardant mixture. FIG. 1A illustrates a crab 102, such as a king crab or stone crab including an exoskeleton 10 and FIG. 1B illustrates a lobster 106 including an exoskeleton 104. The fire retardant of the present disclosure includes portions (or all) of the exoskeleton 104 of either the crab 102, lobster 106, and/or other crustaceans and invertebrates. For example, although FIGS. 1A and 1B illustrate a crab 102 and a lobster 106, the exoskeleton 104 of substantially any type of animal may be used.

The exoskeleton 104 may surround the tissue and other vital organs of the crab 102 and lobster 106. The exoskeleton 104 acts a protective armor for the animals, as well as provides an outer skeleton and platform for muscles, tendons and other tissues to attach. The exoskeleton 104, which may also be considered to be a shell for the animal, may contain chitin (C₈H₁₃O₅N) and/or calcium carbonate (CaCO₃). For example, some invertebrates such as mollusks may have an exoskeleton formed only of calcium carbonate whereas other invertebrates such as crustaceans (e.g., the crab 102 and lobster 106) may have an exoskeleton containing both calcium carbonate and chitin.

In order to utilize the exoskeleton 104, the tissue and other materials (not shown) of the animal may be removed. The crab 102 or lobster 106 itself may discard the exoskeleton 104 during a molting process. In some examples, the exoskeleton 104 may be retrieved after the animal has molted. In other examples, the exoskeleton 104 may be removed and the inner tissue of the lobster 106 or crab 102 may be discarded. Additionally, as crabs 102, lobsters 106 and other animals having an exoskeleton 104 may be a food product, the exoskeleton 104 may often be a waste product of food consumption.

The entire exoskeleton 104 may be used or only a few portions of it may be used. In some instances, the back or top of the animal may have a harder exoskeleton 104 than portions around the joints or underside. Therefore, in some instances the softer areas of the exoskeleton 104 may be discarded and only the hardest portions may be used. In other examples, the entire exoskeleton 104 may be used.

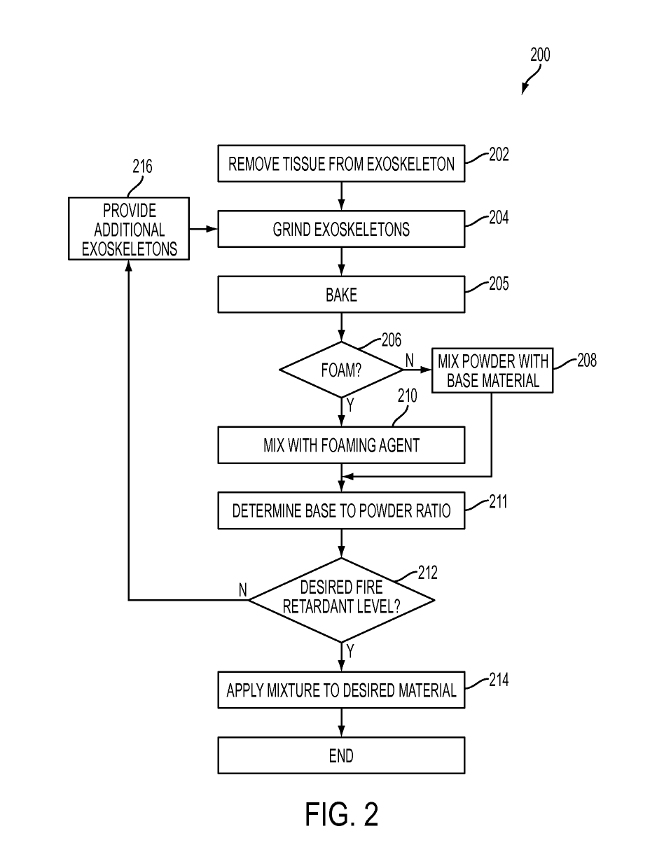

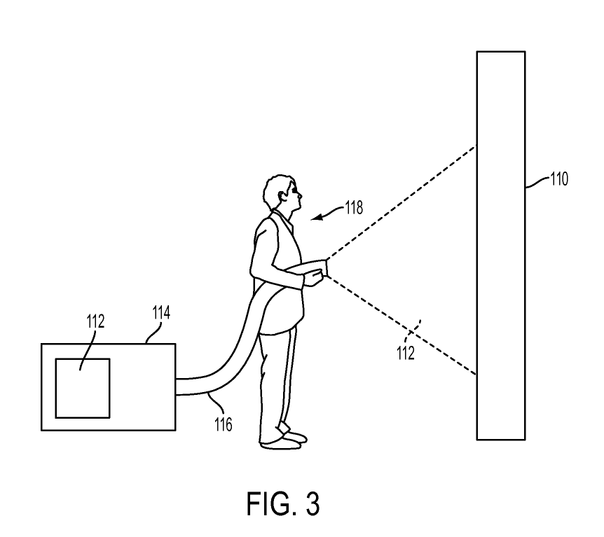

Referring briefly to FIGS. 3 and 4, the exoskeleton 104 may be used to create a fire retardant mixture 112 that may be applied to various materials and/or a material may be created using the fire retardant mixture 112 so that the end product may have an increased fire resistance. This is possible because the exoskeletons 104 of crabs 104, lobsters 106 and other invertebrates may include fire retardant properties.

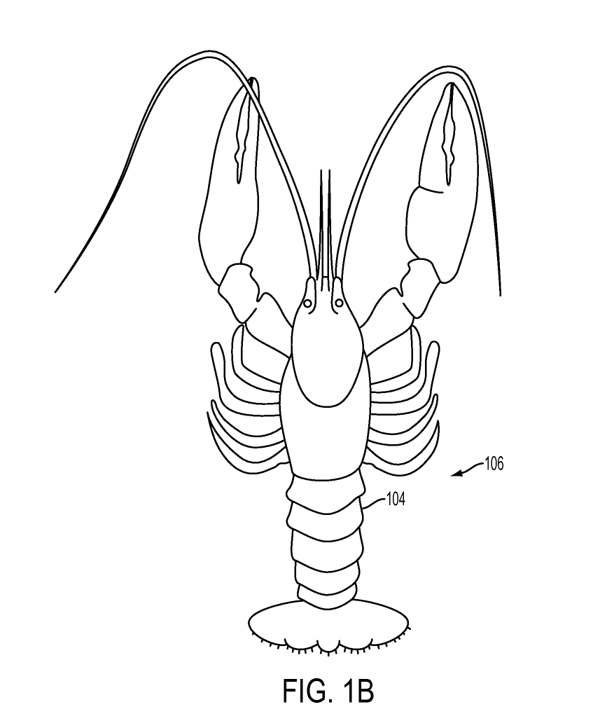

FIG. 2 is a flow chart illustrating an exemplary method 200 for creating a fire retardant mixture 112. The method 200 may begin with operation 202 and the inner tissue may be removed from the exoskeleton 104. After the inner tissue has been removed from the exoskeleton 104, the exoskeleton 104 may be treated. For example, the exoskeletons 104 may be washed with a warm water solution, or may be treated with a antibacterial or other solution. In other examples, the exoskeletons 104 may not be treated, as in operation 205, discussed in more detail below, they may be baked or dried which may prevent any bacteria growth or the like.

Once the tissue has been removed, the method 200 may proceed to operation 204 and the exoskeleton 104 may be ground or broken apart. The exoskeleton 104 may be ground into a powder, dust or may be broken apart into pieces (i.e., larger than powder molecules). The size that the exoskeleton 104 may be broken into or ground may depend on the application. In some applications, larger pieces or chips may be preferable (e.g., as a wall covering) and in other applications a powered of more fine particles (e.g., sugar crystal size) may be desired (e.g., clothing).

After the exoskeleton 104 has been ground or otherwise broken into pieces, the method 200 may proceed to operation 205. In operation 205 the ground exoskeletons 104 may be baked or otherwise dried. In one example, the exoskeleton 104 may be baked at temperatures ranging from approximately 212° F. to approximately 1600° F. The exoskeletons 104 may be baked or dried until substantially all water has been evaporated and the exoskeletons 104 are a bright red color.

In some examples, after the exoskeletons 104 have been baked, the exoskeletons 104 may be ground again, as described in operation 204. In this example, the exoskeletons 104 may be a fine powder, that may be easy to mix with other materials and apply to a base material. However, in other examples, the exoskeletons 204 may only be ground only prior to being baked or dried. In yet other examples, operations 204 and 205 may be reversed, such that the exoskeletons 104 may be baked prior to being ground.

After operation 205, the method 200 may proceed to operation 206. Operation 206 determines whether a foam is desired. A foam may be desired in applications such as applying the fire retardant mixture 112 to building materials or completed structures/devices. For example, if the fire retardant mixture 112 is going to be applied to a ceiling or wall of a building, a foam (which can be sprayed) may be preferred over a powder form. However, in other instances, a powder may be desired.

If a foam is desired, the method 200 proceeds to operation 210 and the exoskeleton 104 is mixed with a foaming agent such as a surfactant which may facilitate the formation of a foam. Additionally, the exoskeleton 104 may also be combined with a fiber (e.g., fiberglass), a plasticizer, or a fiberglass binding material, in order to provide a mixture that may be stable as a foam and may also harden to form a stronger material. It should be noted that although described as a “foam” in some instances the mixture may not form a foam on its own, that is, including bubbles, until it is actually applied. In these examples, the actual foam (bubbles) may only be created when applied through an aerating nozzle or the like. However, other foam production techniques are envisioned.

Furthermore, in some examples, the exoskeleton 104 may be combined with a fireproofing foam, such as spray polyurethane foam, open-cell (low density) polyurethane, fiberglass, and so on. In these examples, the exoskeleton 104 may enhance the fireproof or fire resistant characteristics of the particular base material foam.

If, in operation 206, a foam is not desired, the method 200 may proceed to operation 208. Operation 208 may create a mixture of the ground exoskeleton 104 with a base material or mixing material. The base or mixing material may be virtually any type of material, such as, water, stucco, concrete, plaster, fabric, and so on. It should be noted that in some instances, the base material may be the material in which increased fire retardant properties and/or waterproof properties are desired. However, in other instances, the base material may be separate from the material whose properties are to be affected, e.g., a plaster may be the base or mixing material and may be applied to wood beams to enhance the fire retardant properties of the wood beams.

After operation 206 or after operation 210, the method 200 may proceed to operation 211. Operation 211 determines the ratio of the base or mixing material to the exoskeleton 104 pieces. In the foam form the base material may be a water or other foam-able material. And, in the powder form, the base material may be a concrete, plaster, or the like. The more exoskeleton 104 pieces of the foam or powder mixture compared with the base or mixing material the greater of an increase in the fire resistance characteristics of the fire retardant mixture 112. It should be noted that in some instances, operation 211 may be completed at the time that the foam and/or powder mixture is created. For example, the foam and/or power mixture may be created by adding in known quantities of a particular base material and the exoskeleton 114.

After operation 211, the method 200 may proceed to operation 212. Operation 212 may determine whether the desired fire retardant level is present in the foam and/or powder. The desired level of fire resistance for the fire retardant mixture 112 may be adjusted depending on the application. For example, it may be desirable to have less fire resistance characteristics for clothing as too high of a fire resistance may create stiff or unmovable clothing. Whereas in applications for buildings, stiffness may not be as much of a concern and an increase in the fire resistance properties may be preferred. If in operation 212, the mixture is not yet at the desired level, the method 200 may proceed to operation 216. In operation 216, additional exoskeletons 104 may be provided and the method 200 may proceed back to operation 204.

On the contrary, if in operation 216 the desired level of fire retardant properties is present in the fire retardant mixture 112, the method 200 may proceed to operation 214. Operation 214 applies the fire retardant mixture 112 mixture to the desired material. If the fire retardant mixture 112 is a foam, it may be applied sprayed or otherwise layered onto the desired material. Similarly, if the fire retardant mixture 112 is a powder or semi-liquid it may be coated or covered onto the desired material. Exemplary methods for applying the fire retardant mixture 112 are discussed in more detail below with respect to FIGS. 3 and 4.

FIG. 3 is a block diagram illustrating a user 118 applying the fire retardant mixture 112 onto a wall 110. The fire retardant mixture 112 is stored within an air compressor 114 and then pumped out of the compressor 114 by a motor (not shown). The fire retardant travels through the hose 116 so that the user 118 can apply the fire retardant mixture 112 to the wall 110. In this example, the fire retardant mixture 112 may be a foam that may be applied via the hose 116, which may include an aerating nozzle at its terminal end. In this manner, the fire retardant mixture 112 may include bubbles to allow it to spread as a layer over the wall 110. By applying the fire retardant mixture 112 onto the wall 110 with the air compressor 114, a desired level of thickness for the fire retardant mixture 112 may be achieved. For example, the user 118 may use multiple coats or only a single coat. Additionally, the foam form may allow the fire retardant mixture 112 to disperse substantially evenly over the outer surface of the wall 110.

It should be noted that although an air compressor 114 is illustrated, other devices may be used to apply the fire retardant to a wall 110. Additionally, in some instances, the fire retardant mixture 112 may be applied by the user 118 via a brush or other tool. For example, in some instances, the fire retardant mixture 112 may include a plaster material that may be denser than foam. In these examples, the fire retardant mixture 112 may be applied via a brush, spatula, or other spreading tool.

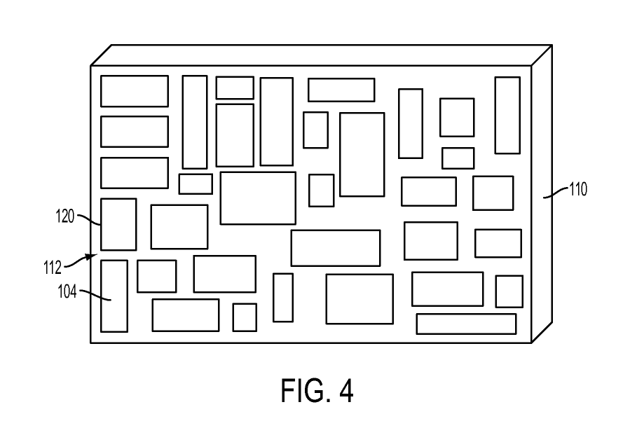

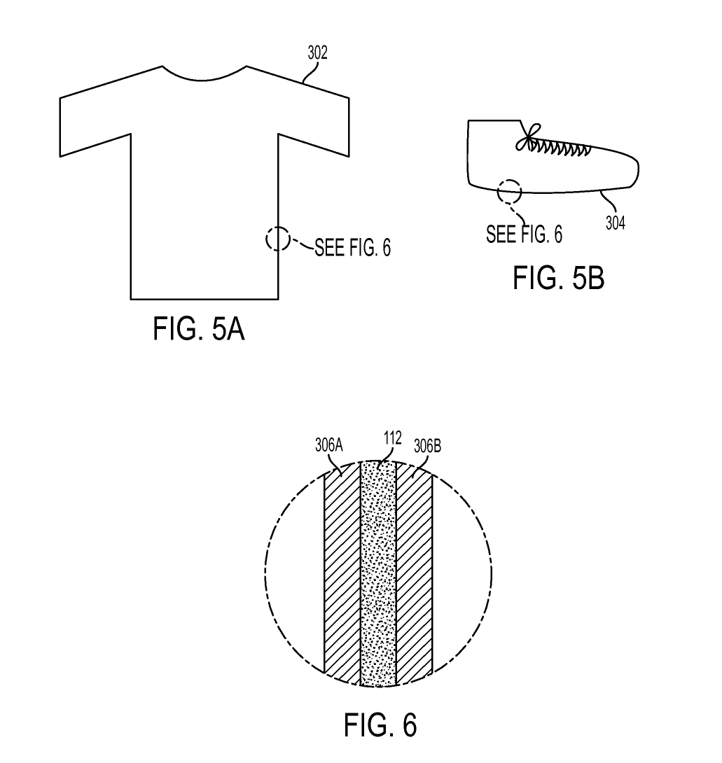

In still other examples, the fire retardant mixture 112 may be applied as a coating to clothing or fabrics. In this example, the fire retardant mixture 112 may be applied after the desired product has been created, e.g., after the clothing item sewn together. In these examples, the fire retardant mixture 112 may be sprayed onto the clothing. However, in other examples, the fire retardant mixture 112 may be included during the manufacture process of the fabric. In this example, the fire retardant may be added as a power mixture to yarn as it is woven to form a fabric, see e.g., FIGS. 5A-6.

Referring again to FIG. 3, although the fire retardant mixture 112 is illustrated as being applied to the wall 110, it should be noted that the fire retardant mixture 112 may be applied to virtually any material where an increased fire resistance is desired. For example, the fire retardant mixture 112 may be applied to building materials for homes, offices, automobiles, ships or boats, airplanes, space technologies (e.g., space shuttles, satellites) and so on. Furthermore, it may also be applied to fabrics, such as clothing, drapes, carpet, and so on.

FIG. 4 illustrates the wall 110 coated with the fire retardant mixture 112 in a different form than the example illustrated in FIG. 3. As shown in FIG. 4, in some examples, the exoskeleton 104 may be broken into pieces and not ground into a powder. The exoskeleton 104 pieces may then be adhered or otherwise applied to the wall 110. For example, the fire retardant mixture 112 may include an adhesive 120 or other mixture suspending the exoskeleton pieces 104 therein. The adhesive 120 or other mixture and the exoskeleton 104 may then be layered onto the wall 110 (or other object/material). The adhesive 120 may be substantially any type of substance may provide support for connecting the exoskeleton 104 pieces to the wall 110 (or other material).

In some examples, the adhesive 120 may be paint, such as latex paint, liquefied rubber paint, and so on. Also, the adhesive 120 may be a plaster such as gypsum plaster, adhesive, caulking, or the like.

With continued reference to FIG. 4, the fire retardant mixture 112 may include the exoskeleton 104 pieces spaced apart from one another. However, in other examples, the exoskeleton 104 may be placed directly next to one another so that there may be substantially no space between each piece. As shown in FIG. 4, the fire retardant mixture 112 may be used in the place of drywall or may be adhered to the drywall of a building.

In still other examples, the fire retardant mixture 112 may be combined with other materials to form drywall material. The fire retardant mixture 112 may be combined with other substances to form a core of a paper liner that may be hardened to form drywall panels. For example, a drywall core may include gypsum (CaSO₄2H₂O), which may be calcined to produce a plaster. The plaster than may be mixed with fiberglass (or other fiber), a plasticizer, foaming agent, ground gypsum crystal, ethylenediaminetetraacetic acid, chelate or starch, and the fire retardant mixture 112. Other types of general drywall mixtures are envisioned, and the above mixture is simply one example. The core including the plaster mixture may be dried or otherwise set. The drywall material include the fire retardant mixture 112 may then be used as a building material. In this example, the fire retardant properties of the drywall panel may be increased due to the inclusion of the fire retardant mixture 112. This may allow the drywall panel to better maintain its structure and resist being destroyed due to a fire or heat.

The fire retardant mixture 112 may be combined with other materials to provide fire proof properties as well as enhance other properties of the materials. FIG. 5A is a front elevation view of an article of clothing 302 including the fire retardant mixture 112. FIG. 5B is a front elevation view of a shoe including the fire retardant mixture 112. As described above in FIG. 3, the fire retardant mixture 112 may be applied to the base materials (clothing 302 and shoe 304) in a variety of different manners. In some examples, the fire retardant mixture 112 may be interwoven within the materials of the article of clothing 302 and/or the shoe 304.

FIG. 6 is an enlarged view of the clothing 302 and shoe 304 illustrating the fire retardant mixture 112 layered between a first material 306A and a second material 306B. The first and second materials 306A, 306B may be substantially any type of materials, such as water proof materials, e.g., GOR-TEX, fabric materials, plastic, leather, and so on. The layering of the fire retardant mixture 112 and the materials 306A, 306B may increase the waterproof and fireproof properties of the article, e.g., the clothing 302 or the shoe 304.

It should be noted that in some instances the first and second materials 306A, 306B may be the same material and in other examples, the first and second materials 306A, 306B may be different materials. In one example, the first material 306A may be a waterproof material, such as, thermo-mechanically expanded polytetrafluoroethylene (PTFE), other fluoropolymer products, rubber, polyvinyl chloride (PVC), polyurethane (PU), silicone elastomer, fluoropolymers, and so on. The second material 306B may be another type of material, such as a fabric, leather, and so on. As the fire retardant mixture 112 may be sandwiched between each of the materials 306A, 306B the article, clothing 302, shoe 304, or other item, may have an increased waterproof properties as well as increased fireproof properties. Additionally, as the fire retardant mixture 112 may be layered between material, the fire retardant mixture 112 may be substantially hidden from view, so that a desired texture and/or appearance of the clothing 302 and/or shoes 304 may be viewable.

In still other examples, the fire retardant mixture 112 may combined with the base material to create handles for pots and pans. In these examples, the base material may be rubber and the fire retardant mixture 112 may be combined with the rubber or may be applied to an outer surface of the rubber. Additionally, the fire retardant material 112 may be combined with other flooring or ceiling materials, creating fire retardant building materials. In one example, the fire retardant mixture 112 may be combined with wood-plastic composites made of wood fiber/flour and plastic(s) (such as TREX), laminate tile flooring, vinyl, ceiling panels or tiles (e.g., wood fiber, mineral fiber), and so on. In these examples, the fire retardant mixture 112 may be either combined with the base materials before the final product is formed, e.g., before the ceiling tiles are created, or the fire retardant mixture 112 may be applied to the final product (e.g., after the tiles have been created).

### Conclusion

The foregoing description has broad application. For example, while examples disclosed herein may focus on creating a fire retardant mixture with multiple materials, it should be appreciated that the concepts disclosed herein may equally creating a fire retardant material from exoskeletons alone. Similarly, although the fire retardant may be discussed with respect to utilizing the exoskeletons of aquatic invertebrates, the devices and techniques disclosed herein are equally applicable to fire retardants utilizing similar materials to those of exoskeletons of non-aquatic invertebrates. Accordingly, the discussion of any embodiment is meant only to be exemplary and is not intended to suggest that the scope of the disclosure, including the claims, is limited to these examples.

I claim:

1. A method for creating a fire retardant mixture comprising:
grinding an exoskeleton of an aquatic invertebrate into a powder;
mixing the ground exoskeleton with a mixing material; and
applying the mixture to a base material.

2. The method of claim 1, wherein the mixing material is one of a plaster or paint.

3. The method of claim 1, wherein the exoskeleton is from a king crab or a lobster.

4. A method for creating a fire retardant mixture comprising:
grinding at least a portion of a crustacean outer shell into particles;
dispensing the particles into a base substance; and
mixing the particles and the base substance to form a third material.

5. The method of claim 4, further comprising applying the third material to a fourth material.

6. The method of claim 5, wherein the fourth material is a fabric.

7. The method of claim 5, wherein the fourth material is one of a metal, wood, plastic, composite, or alloy.

8. The method of claim 5, wherein applying the third material to the fourth material includes spraying the third material through an aerating nozzle to form a foam and coating the fourth material with the foam.

9. The method of claim 8, wherein the base substance includes a foaming agent.

10. The method of claim 4, wherein the base substance is an adhesive.

11. The method of claim 4, wherein the base substance is a plaster.

12. A drywall panel comprising:
a liner;
a core inserted within the liner and including
a plaster; and
a fire retardant having pieces of an exoskeleton of an invertebrate suspended within the plaster.

13. The drywall panel of claim 12, wherein the exoskeleton is from one of a crab or a lobster.

14. The drywall panel of claim 12, wherein the plaster includes gypsum.
